(19) United States
(12) Patent Application Publication
(10) Pub. No.: US 2026/0184543 A1
(43) Pub. Date: Jul. 2, 2026

(54) LOCKING DEVICE FOR A TELESCOPIC CYLINDER

(71) Applicant: LIEBHERR-COMPONENTS KIRCHDORF GMBH, Kirchdorf (DE)

(72) Inventors: Markus SCHUSTER, Ottobeuren (DE); Stefan HUMMEL, Grönenbach (DE); Michael Martin HEINZ, Altenstadt (DE)

(21) Appl. No.: 18/859,521

(22) PCT Filed: Apr. 11, 2023
(86) PCT No.: PCT/EP2023/059383

§ 371 Date: Oct. 23, 2024

(30) Foreign Application Priority Data
Apr. 28, 2022 (DE) 10 2022 110 364.1
Apr. 6, 2023 (DE) 10 2023 108 833.5

(51) Int. Cl. B66C 23/70

(52) U.S. Cl. CPC B66C 23/708

(57) ABSTRACT

Locking device for the telescopic cylinder of a telescopic boom comprising a plurality of telescopic stages. The locking device comprises a housing, at least one bolt displaceably mounted in the housing for locking the telescopic cylinder with a telescopic stage, a yoke displaceably mounted in the housing, which is movable into an unlocking position for releasing a locking bolt of the telescopic boom, and at least one blocking element, which blocks a movement of the bolt into its unlocking position when the yoke is in the unlocking position. The at least one bolt is preloaded into a locking position and can be displaced via at least one bolt actuator into an unlocking position releasing the telescopic stage lock. The blocking element and the bolt can be at least partially displaced into a common insertion space of the housing.

### CROSS REFERENCE TO RELATED APPLICATIONS

The present application is a U.S. National Phase of International Application No. PCT/EP2023/059383 entitled “LOCKING DEVICE FOR TELESCOPIC CYLINDER,” and filed on Apr. 11, 2023. International Application No. PCT/EP2023/059383 claims priority to German Patent Application No. 10 2022 110 364.1 filed on Apr. 28, 2022, and claims priority to German Patent Application No. 10 2023 108 833.5 filed on Apr. 6, 2023. The entire contents of each of the above-listed applications are hereby incorporated by reference for all purposes.

### TECHNICAL FIELD

The invention relates to a locking device for the telescopic cylinder of a telescopic boom comprising a plurality of telescopic stages according to the preamble of claim 1 and to an implement, in particular a mobile crane, having such a device.

### BACKGROUND AND SUMMARY

Telescopic booms comprise an outer telescopic stage (also known as a base stage or articulated stage) and one or more inner telescopic stages that can be moved within it. Telescopic booms of this type are used on mobile cranes, for example. For larger telescopic booms in particular, a hydraulic telescopic cylinder is generally used to telescope the telescopic stages in and out, which moves the inner telescopic stages in and out sequentially. For this purpose, one part of the telescopic cylinder, typically its piston rod, is connected to the base of the outer telescoping section, while the other part, typically the cylinder, moves in and out relative to the outer telescoping section by pressurising the corresponding pressure chamber.

In order to be able to move the individual telescopic stages, the telescopic cylinder must be temporarily connected to them. The solution typically used for this purpose provides a locking device (also known as a locking head) on the telescopic cylinder, in particular at its piston rod end or collar, which engages from the inside via several spring-loaded bolts in the inner telescopic stage to be extended, so that the telescopic stage extends together with the telescopic cylinder.

The individual telescopic stages can also be locked together in defined extension positions via locking bolts spring-mounted on the telescopic stages. In order to unlock or close locking bolts for extending or retracting telescopic stages, these can be gripped by the locking device and moved into an unlocking position. For this purpose, the locking device usually has a spring-loaded yoke which can be brought into engagement with pull mushrooms of locking bolt rods projecting inwards into the telescopic stages.

Hydraulic actuators are used to move the bolts and the yoke into the respective unlocking position against the restoring forces. Safety bolts installed on the yoke mechanism ensure that the bolts cannot be retracted at the same time when the yoke is in the unlocking position and that the free or unlocked telescopic stage is therefore held by the telescopic cylinder. This is typically achieved by the locking bolts blocking the travel of the bolts. If the yoke is in the locking position, however, the travel of the bolts is free and they can be moved into the unlocking position by pressurising the corresponding actuators.

In generic devices, the yoke is displaceably mounted and guided by several guide elements in a housing of the locking device. In some known solutions, these guide elements are arranged outside the centre plane, which is spanned by the longitudinal axes of the lateral bolts and the direction of displacement of the yoke, while the locking bolts are located within this centre plane. However, this requires a relatively large installation space and can lead to the yoke jamming in the housing. However, if the guide elements are to be moved to said centre plane, there is a spatial conflict with the actuation and return mechanism of the bolts in generic devices, which are usually preloaded by return springs arranged in the centre. As a result, the return springs of the yoke must be arranged outside the centre plane, which in turn requires a larger installation space.

The object of the present invention is therefore that of avoiding the disadvantages of the prior art and further developing it in an advantageous manner. In particular, in a locking device for telescopic booms of the same type, good guidance of the yoke in the housing is to be ensured with optimum utilisation of the installation space.

This problem is solved by a locking device having the features of claim 1. Advantageous embodiments of the invention can be found in the dependent claims and the following description.

Accordingly, a locking device is proposed for the telescopic cylinder of a telescopic boom, which comprises a plurality of telescopic stages mounted so as to be displaceable one inside the other. The locking device comprises a housing, at least one bolt displaceably mounted in the housing for locking the telescopic cylinder with a telescopic stage, a yoke displaceably mounted in the housing, which can be moved into an unlocking position for releasing a locking bolt of the telescopic boom, and at least one blocking element, which blocks movement of the bolt into its unlocking position when the yoke is in the unlocking position. The at least one bolt is preloaded into a locking position via at least one bolt return element and can be displaced into an unlocking position that releases the telescopic bolt lock via at least one bolt actuator. The blocking element and the bolt are at least partially displaceable into a common insertion space of the housing. The at least one blocking element prevents both the yoke and the at least one bolt from being in the unlocking position at the same time. This ensures that either all telescopic stages are locked together via one or more locking bolts or that the locking device is locked to one of the inner telescopic stages and the latter is therefore held or secured by the telescopic cylinder. The yoke and the at least one bolt thus block each other so that each of these elements can only be moved into the unlocking position when the other element is in the locking position.

According to the invention, the bolt is preloaded into the locking position via at least two bolt return elements, wherein the blocking element is arranged between the bolt return elements as seen in the direction of displacement of the yoke. The latter can also include the case that the blocking element is offset in relation to the bolt return elements but is arranged between their extended longitudinal axes. Preferably, however, the bolt return elements are actually arranged around the blocking element.

This configuration enables a compact design of the locking device, as the installation space previously occupied by the central bolt return spring in the area of the longitudinal axis of the bolt is now free and is used for the locking element. With known solutions, on the other hand, the locking bolts had to be provided with special recesses, as the locking bolts and the central bolt return springs were in each other's way. In particular, the arrangement according to the invention makes it possible to arrange a yoke return element in the area of the at least one blocking element, whereby a very compact structure is achieved.

At the same time, the configuration is very easy to assemble. Individual parts can be advantageously pre-assembled.

The bolt return elements are preferably springs or compression springs. These can be guided by means of spring mandrels. It is also conceivable that the springs can be pre-tensioned using screws before installation. This enables safe installation and maintenance of the system.

In one possible embodiment, it is provided that the at least one blocking element is also designed as a guide element, via which the yoke is guided in the housing. Preferably, the blocking element has a guide portion which is displaceably mounted and guided in a guide of the housing. The guide portion is preferably cylindrical.

The at least one blocking element therefore performs a dual function, namely on the one hand guiding the yoke in the housing and on the other hand blocking the unlocking movement of the bolts when the yoke is in the unlocking position. This combined function means that, apart from the at least one blocking element, no other guide elements need to be provided to support or guide the yoke in the housing. This means that less space is required within the locking device.

In addition, the actuators for moving the yoke into the unlocking position (yoke actuators) can be arranged in one plane with the blocking element acting as a guide element, whereas in the prior art, a displaced arrangement of locking bolt and/or yoke actuators on the one hand and guide elements on the other is often provided in the direction of displacement of the bolt. This results in improved guidance of the yoke in the housing, as no additional torque is introduced into the device, which would reduce the ease of movement of the yoke.

The yoke actuators can be designed as plunger cylinders, for example. Similarly, return elements that pretension the yoke in the locking device (yoke return elements), such as compression springs, do not in themselves constitute guide elements within the meaning of the invention. Rather, the guide elements of the locking device according to the invention serve primarily to guide the yoke in the housing during a movement from the locking position to the unlocking position and vice versa.

In a further possible embodiment, it is provided that the bolt return elements run perpendicular to the longitudinal axis of the blocking element. In particular, the bolt return elements are oriented parallel to the longitudinal axis or direction of displacement of the bolt.

Alternatively or additionally, the bolt return elements can run at least partially within the insertion space. The at least one blocking element can be at least partially surrounded by the bolt return elements or the latter can be arranged on both sides of the blocking element in the insertion space.

In a further possible embodiment, it is provided that the bolt is preloaded into the locking position via at least two, preferably exactly four, bolt return elements. Preferably, the bolt return elements are arranged symmetrically to the longitudinal axis of the bolt or to a plane running through the longitudinal axis of the bolt.

Alternatively or additionally, the bolt return elements are arranged symmetrically to the longitudinal axis of the blocking element when viewed in the direction of displacement of the bolt. This includes the case that the bolt return elements are arranged symmetrically to a plane containing the longitudinal axis of the blocking element, in particular symmetrically to a plane spanned by the longitudinal axis of the blocking element and the longitudinal axis of the bolt.

In a further possible embodiment, it is provided that the yoke is preloaded into a locking position via at least one yoke return element and can preferably be displaced into the unlocking position against the preload force of the yoke return element via at least one yoke actuator. The yoke actuator can be designed to push the yoke into the unlocking position or to pull the yoke into the unlocking position. The yoke return element can be a compression spring.

In a further possible embodiment, the blocking element has a blocking portion which, in the unlocking position of the yoke, projects into a travel path of the bolt in the insertion space and blocks movement of the bolt in its unlocking position. If the yoke is in the locking position, the blocking portion is outside the bolt travel path. The blocking portion preferably has no recess and/or a constant width when viewed from the side along the travel path of the bolt.

The blocking element preferably also has a contact portion that is connected to or contacted by the at least one yoke actuator. The contact portion preferably runs transversely to the longitudinal axis of the blocking element. The blocking element is connected to the yoke so that pushing down (in the case of a “pushing” yoke actuator) or pulling down (in the case of a “pulling” yoke actuator) the contact portion causes the yoke to be moved into the unlocking position. The contact portion is preferably located above (if the side of the locking device on which the yoke is located is regarded as “above”) the blocking portion.

In a further possible embodiment, two yoke actuators are provided, which are preferably arranged symmetrically to the blocking element when viewed in the direction of displacement of the bolt. The yoke actuators are therefore located on both sides of the blocking element as seen in the direction of displacement of the bolt and are at the same distance from it. This can advantageously ensure that no additional torque is introduced into the blocking element via the yoke actuators.

In another possible embodiment, the yoke return element is a compression spring that is arranged coaxially to the blocking element. This results in a particularly space-saving arrangement in which the compression spring acts axially on the blocking element and is arranged within the insertion space between the bolt return elements. In particular, several compression springs do not have to be arranged at a distance from the blocking element, as is common in the prior art, which would increase the required installation space. Preferably, the compression spring is partially accommodated in a spring receptacle of the blocking element. The spring receptacle of the blocking element can be realised by a recess open at the bottom (i.e. facing away from its attachment to the yoke), in which the compression spring is seated.

Alternatively or additionally, the compression spring can be mounted or guided on a spring mandrel connected to the housing. Ideally, the compression spring can be pre-tensioned via a pre-tensioning element, for example a threaded spindle, for easy assembly. However, conventional mounting is also possible.

In a further possible embodiment, it is provided that the yoke return element is arranged at least partially in the insertion space, wherein the bolt preferably has a recess on an end face facing the yoke return element, which at least partially encloses or surrounds the yoke return element in the unlocking position of the bolt. Thus, the yoke return element as such does not block the movement of the bolt into the unlocking position. In particular, the recess of the bolt is U-shaped and surrounds the yoke return element in the unlocking position. The blocking element is preferably designed in such a way that it cannot be embraced by the recess of the bolt in the unlocking position of the yoke, i.e. it is wider than the recess. Alternatively, the blocking portion of the blocking element can also block the bolt at a different point, for example to the side of the recess. Preferably, the recess or the blocking element is designed in such a way that the bolt in its unlocking position blocks the blocking element from retracting and thus blocks the yoke from moving into its unlocking position.

In a further possible embodiment, it is envisaged that the yoke actuator comprises or represents a hydraulic cylinder, in particular a plunger cylinder. A plunger is suitable for a particularly space-saving arrangement within the structure of the locking device. In particular, it can be easily arranged above the area of the insertion space, for example perpendicular to the bolt. Preferably, the blocking element is activated by two plungers.

In a further possible embodiment, it is envisaged that the bolt actuator comprises or represents a hydraulic cylinder, in particular a plunger cylinder. Preferably, several plungers are provided for the movement of the bolt. The plungers are advantageously arranged symmetrically with respect to the longitudinal axis of the blocking element when viewed in the direction of displacement of the bolt. This includes the case that the plungers are arranged symmetrically to a plane containing the longitudinal axis of the blocking element, in particular symmetrically to a plane spanned by the longitudinal axis of the blocking element and the longitudinal axis of the bolt. This results in a uniform movement of the bolt without the generation of additional torques.

In a further possible embodiment, two bolts are provided for locking the telescopic cylinder with a telescopic stage, wherein each bolt is associated with at least one blocking element which, viewed in the direction of displacement of the yoke, is arranged between its bolt return elements. The bolts are located in particular on opposite sides of the locking device, while the yoke is arranged on the upper side of the latter. The preceding remarks on possible configurations of the yoke, the bolts, the blocking element and the various return elements and actuators apply analogously to an embodiment with two bolts.

In particular, exactly one blocking element is provided per bolt. Preferably, the yoke is therefore preloaded into the locking position via a total of two yoke return elements and can be moved into the unlocking position via at least four, in particular exactly four, yoke actuators. Each of the two bolts is held in the locking position by a blocking element when the yoke is in the unlocking position.

In particular, the two blocking elements also act as guide elements, as described above. In one embodiment, no further guide elements are provided in addition to these two guide elements formed by the blocking elements, so that the yoke is mounted and guided in the housing via exactly two guide elements. These two guide elements are located in particular within a centre plane running through the middle of the yoke, in which the longitudinal axes of the bolts are preferably also located.

In an alternative possible embodiment, exactly two blocking elements are provided, which act as guide elements, wherein a further guide element is additionally provided so that the yoke is guided in the housing via a total of three guide elements. The further guide element is preferably arranged outside a centre plane spanned by the longitudinal axes of the blocking elements. In particular, the further guide element comprises a guide rod connected to the yoke or to an underside of the yoke, which guide rod is displaceably mounted and guided in a guide of the housing.

In principle, however, it is also conceivable that more than one additional guide element is provided, so that the yoke, including the two blocking elements acting as guide elements, is mounted and guided in the housing so that it can be moved by a total of four, five or more guide elements.

In a further possible embodiment, it is provided that the blocking elements are arranged centrally on opposite sides of the yoke, wherein the longitudinal axes of the blocking elements preferably lying in a common plane with the longitudinal axes of the bolts.

In a further possible embodiment, it is provided that exactly four yoke return elements are provided, which are arranged axially symmetrically to a centre plane spanned by the longitudinal axes of the blocking elements and preferably axially symmetrically to a plane running perpendicularly thereto.

In a plan view of the locking device, four yoke return elements are preferably provided, which form the corners of a rectangle.

In a view along the direction of movement of the bolts, preferably two or four bolt return elements are provided, which form the corners of a rectangle.

In a view along the direction of movement of the bolts, four bolt actuators are preferably provided, which form the corners of a rectangle.

In a further possible embodiment, it is provided that an end portion of the blocking element projecting into a stroke path or travel path of the bolt within the insertion space has an opening completely enclosed by a wall on its end face. The end portion can form a blocking portion of the blocking element, as described further above. In particular, the end portion therefore does not have a recess open to one side, such as a C-shaped portion seen from the side. The opening is preferably circular. Preferably, the opening serves to accommodate the yoke return element, so that it projects from the insertion space through the opening into a spring receptacle of the blocking element or is accommodated therein. In particular, the spring receptacle can be enclosed by the aforementioned wall, at least a part of the spring receptacle.

In a further possible embodiment, it is provided that a mandrel receiving space adjoins the spring receptacle, wherein the mandrel receiving space is formed within the blocking element. The mandrel receiving space is designed in such a way that a spring mandrel running in the insertion space and on which the yoke return element is mounted projects into the mandrel receiving space in an unlocking position of the yoke (in which the blocking element blocks the stroke path or travel path of the bolt), so that it is located at least partially inside the blocking element in said mandrel receiving space. Furthermore, the spring receptacle and the mandrel receiving space are designed in such a way that the yoke return element is always located outside the mandrel receiving space, i.e. does not protrude into the mandrel receiving space in any position of the yoke or the blocking element. Preferably, the mandrel receiving space has a smaller diameter than the spring receptacle. The mandrel receiving space can have a circular cross-section.

The present invention also relates to an implement, in particular a mobile crane, having a telescopic boom comprising a plurality of telescopic stages which are displaceably mounted one inside the other, a hydraulic telescopic cylinder for extending and retracting at least one inner telescopic stage, and a locking device according to the invention which is connected to the telescopic cylinder. Obviously, the same properties and advantages arise as in the case of the locking device according to the invention, which is why a repetitive description is dispensed with at this juncture.

### BRIEF DESCRIPTION OF THE FIGURES

Further features, details and advantages of the invention can be found in the exemplary embodiments explained below with reference to the figures, in which:

FIG. 1: shows a perspective view of a first exemplary embodiment of the locking device according to the invention;

FIGS. 2a-b: show the locking device according to FIG. 1 in a frontal view and in a frontal sectional view through the two blocking elements;

FIG. 3: shows a plan view of the locking device according to FIG. 1 in a section through the bolts at the level of the bolt return elements;

FIGS. 4a-b: show a side view of the locking device according to FIG. 1 and a side sectional view through a blocking element;

FIGS. 5a-b: show a second exemplary embodiment of the locking device according to the invention in a frontal sectional view through the two blocking elements and in a plan view; and FIGS. 6a-c: show a third exemplary embodiment of the locking device according to the invention in a frontal sectional view through the two blocking elements, in a lateral sectional view through a blocking element and in a perspective single view of one of the blocking elements.

### DETAILED DESCRIPTION

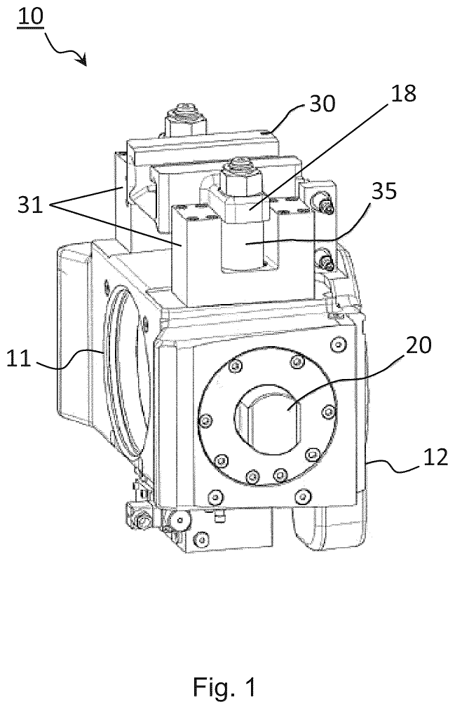

FIG. 1 shows a perspective view of a first exemplary embodiment of the locking device 10 according to the invention. The locking device 10 represents a locking head of the telescopic cylinder of a telescopic boom with several telescopic stages mounted so that they can slide inside one another. This can be the telescopic boom of a mobile crane. The locking head 10 is used to lock the telescopic stages to each other and to lock the telescopic cylinder to an inner telescopic stage as described above. The telescopic cylinder and the telescopic stages are not shown here.

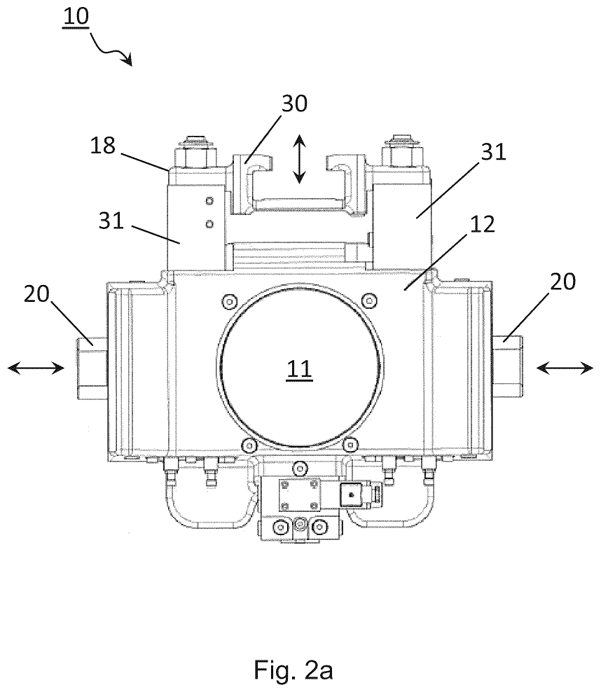

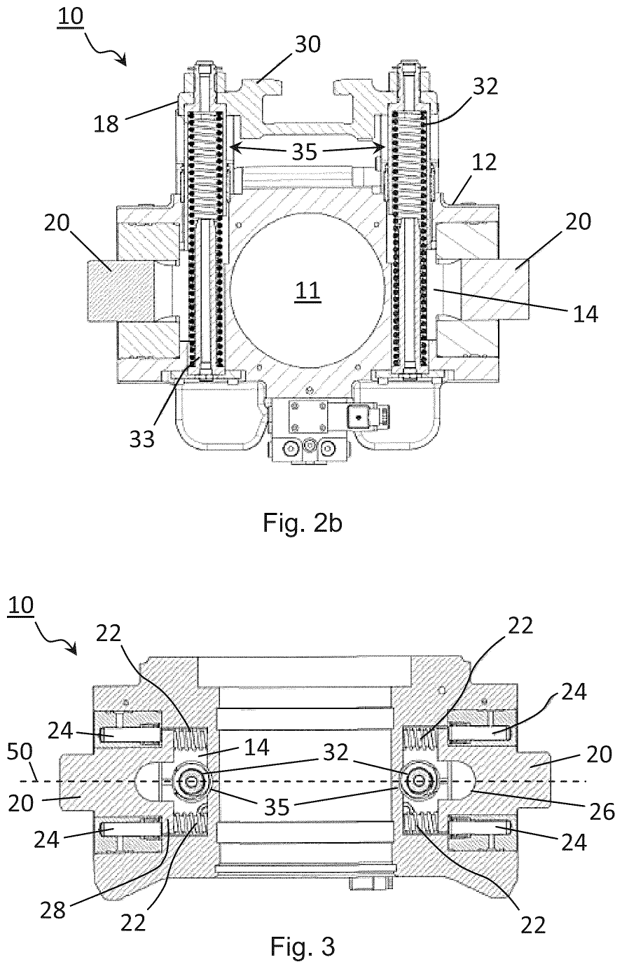

To lock the locking device 10 with a telescopic stage, bolts 20 (also referred to as carrier bolts) are provided on opposite sides of the locking device 10, which are slidably mounted in a housing 12 of the locking device 10 (see FIG. 2a). The longitudinal axes of the bolts 20 are arranged collinearly. The bolts 20 can engage in corresponding recesses of a telescopic stage to be moved and entrain it with an extension or retraction movement of the telescopic cylinder.

As can be seen in the frontal view of the locking device 10 in FIG. 2a, the housing 12 has a central opening or recess 11, in which the telescopic cylinder, not shown here, is accommodated. A clamp-shaped yoke 30 (also known as a pulling yoke), which is open at the upper side, is arranged above the recess 11 on the upper side of the locking cone 10. The yoke 30 is used to grip and pull a locking bolt in order to release the locking of two telescopic stages from each other.

FIG. 2b shows a section through the locking device 10 perpendicular to the central recess 11 along the longitudinal axes of the bolts 20 (front view) and thus provides a view of the inner workings of the locking device 10. A section along the central recess 11 through the bolts 20 (plan view) is shown in FIG. 3.

As the double arrows in FIG. 2a indicate, the yoke 30 can move perpendicular to the direction of displacement of the bolts 20. The yoke 30 is pressed or pretensioned upwards into a locking position by two yoke return elements 32 in the form of compression springs. The compression springs 32 are arranged diametrically on opposite sides of the yoke 30, namely in plan view (see FIG. 3) in a line with the longitudinal axes of the bolts 20. The longitudinal axes of the compression springs 32 and the longitudinal axes of the bolts 20 are perpendicular to each other and lie in a common centre plane 50, which in particular runs through the centre of the yoke.

In order to pull a locking bolt and thus release the locking of two telescopic stages, four hydraulic yoke actuators 34 in the form of plungers are provided in the exemplary embodiment shown here, which are arranged in pairs on opposite sides of the yoke 30 in the area of the compression springs 32. By pressurising the plungers 34, which are displaceably mounted in plunger housings 31 arranged adjacent to the yoke 30, the yoke 30 can be pressed downwards (i.e. in the direction of the recess 11) into an unlocking position against the spring forces of the compression springs 32. As soon as the plungers 34 are no longer pressurised, the compression springs 32 automatically push the yoke 30 back into the locking position.

The bolts 20 are also preloaded into their locking position via bolt return elements 22 in the form of compression springs. In the exemplary embodiment shown here, exactly four compression springs 22 are provided per bolt 20, which press the respective bolt 20 outwards (i.e. away from the recess 11). Alternatively, only two compression springs can be provided. Hydraulic bolt actuators 24 can be used to move the bolts 20 against the force applied by the compression springs 22 in the direction of the central recess 11 and thus into an unlocking position.

For safety reasons, it must be prevented that the yoke 30 and the bolts 20 can be in their unlocking positions at the same time, so that the telescopic stages are locked either to each other or to the locking device 10 at all times. A safety mechanism is provided for this purpose, which only allows the bolts 20 to move into their unlocking positions when the yoke 30 is in the locking position and vice versa. The safety mechanism comprises two blocking elements 35, which are arranged diametrically on opposite sides of the yoke 30 and coaxially to the yoke return elements or compression springs 32.

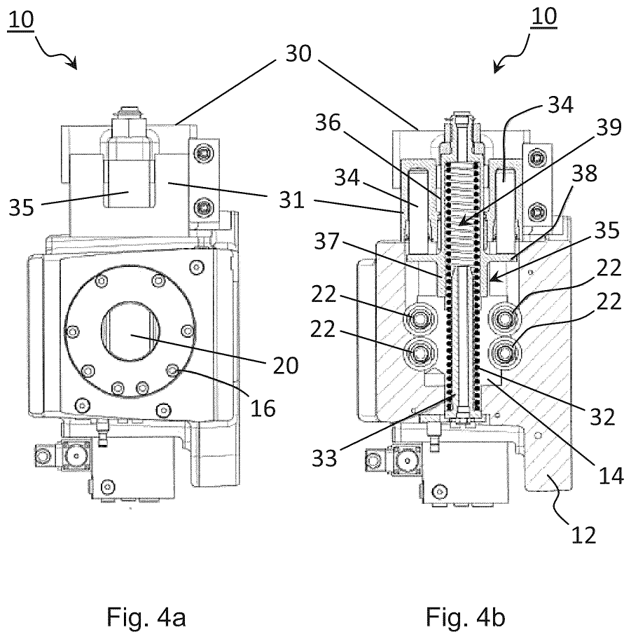

FIG. 4a shows a side view of the locking device 10 with a view of one of the lateral bolts 20, while FIG. 4b shows a section perpendicular to the longitudinal axis of the bolt through the housing 12 in the area of one of the blocking elements 35 (side view).

The blocking elements 35 are firmly connected to the yoke 30 in their upper end areas. For this purpose, the yoke 30 has laterally projecting connection areas 18, to which the blocking elements 35 are fastened (in particular via a screw connection, wherein other fastening means are of course also conceivable). The blocking elements 35 extend inwards into the housing 12 parallel to the direction of movement of the yoke 30. The blocking elements 35 have downwardly open recesses which form spring receptacles 39 in which the compression springs 32 are accommodated. The compression springs 32 are mounted or guided on spring mandrels 33 (see FIGS. 2b and 4b), which are attached to the housing 12.

The spring mandrels 33 or the compression springs 32 run through an insertion space 14 within the housing 12, into which the bolts 20 are also pushed when they move into the unlocking position (see FIGS. 2b and 3). The lower areas of the blocking elements 35 form blocking portions 37, which are located above the bolts 20 when the yoke 30 is in the locking position. In this state, the blocking portions 37 therefore do not protrude into the insertion spaces 14 of the bolts 20.

Due to their central arrangement, the compression springs 32 would block an inward movement of the bolts 20. For this reason, the bolts 20 each have a U-shaped recess 26 (in plan view) on their end faces facing the compression springs 32, the width of which is greater than the diameter of the compression spring 32 (see FIG. 3). The recesses 26 are thus designed in such a way that, when the bolts 20 are moved into the unlocking position, they engage around the compression springs 32, but the bolts 20 do not collide with the compression springs 32, i.e. the compression springs 32 are accommodated in the recesses 26 in the unlocking position.

If, on the other hand, the yoke 30 is in the unlocking position, the blocking portions 37 protrude into the insertion spaces 14 and block the movement of the bolts 20 into the unlocking position. For this purpose, the recesses 26 are designed in such a way that they do not surround the blocking portions 37 of the blocking elements 35, i.e. they have a smaller width than the blocking portions 37 (see FIG. 3). Conversely, the bolts 20 block the retraction of the blocking elements 35 in their unlocking position, so that the yoke 30 cannot move into the unlocking position in this state.

Above the blocking portions 37, the blocking elements 35 each have a laterally projecting contact portion 38, which can be seen in FIG. 4b. The contact portion 38 comprises two contact surfaces projecting perpendicular to the longitudinal axis of the corresponding blocking element 35, which are connected to the plungers 34 or are contacted by these from above. By extending the plungers 34, the blocking element 35 and thus the yoke 30 connected to it is moved downwards into the unlocking position.

In the exemplary embodiment shown here, the plungers 34 and the blocking element 35 are each arranged in a common plane on each side of the yoke 30, i.e. they are not offset in the direction of movement of the bolts 20. This enables a compact design of the locking device 10 and avoids the introduction of additional torques into the blocking elements 35. However, it is also possible in principle to arrange the plungers 34 offset to the blocking elements 35 in the direction of movement of the bolts 20.

The central arrangement of the compression springs 32 and the blocking elements 35 in relation to the bolts 20 is achieved by the fact that, in contrast to the prior art, the bolts 20 are not each mounted via a central spring, i.e. arranged along the longitudinal axis of the bolt. Instead, each bolt 20 is preloaded via several compression springs 22 (four in the present exemplary embodiment), which are located laterally next to the blocking elements 35. As can be seen in FIGS. 3 and 4b, the compression springs 22 are arranged in pairs on both sides of the compression springs 32, looking along the direction of displacement of the bolts 20. The space thus freed up in the area of the longitudinal axis of the bolt is taken up by the compression springs 32 or the blocking elements 35. This results in a particularly compact design of the locking device 10. The possibility of dispensing with separate compression springs and instead arranging them coaxially to the blocking elements 35 also ensures a simpler design of the blocking elements 35.

At the ends facing the blocking elements 35, the bolts 20 have laterally projecting contact portions 28. The compression springs 22 are attached to these contact portions 28 on the side of each bolt 20 facing the insertion space 14, i.e. the compression springs 22 are arranged in the insertion space 14. The compression springs 22 can be mounted on spring mandrels. The bolt actuators 24, which in this exemplary embodiment are also designed as plunger cylinders 24, are located on the side of the contact portions 28 of each bolt 20 facing away from the insertion space 14. By extending the plungers 24, the bolts 20 are pressed in the direction of the compression springs 32 and thus moved into the unlocking position.

In the exemplary embodiment shown here, four plungers 24 are provided per bolt 20 and can also be arranged in pairs on both sides of the compression springs 32 or the blocking elements 35, as seen along the direction of displacement of the bolts 20. Alternatively, only two plungers 24 or more than two plungers 24 can be provided per bolt 20.

The blocking elements 35 also represent the guide elements of the yoke 30 in the housing 12, which ensure a stable travelling movement of the yoke 30. For this purpose, the blocking elements 35 each have a cylindrical guide portion 36 in particular above the contact portions 38. Via the guide portions 36, the blocking elements 35 are displaceably mounted and guided in guides or lead-throughs of the housing 12 of the locking device 10.

In the exemplary embodiment shown here, the blocking elements 35 are guided through recesses in the plunger housings 31 arranged laterally next to the yoke 30, which substantially have an angular U-shape. The blocking elements 35 are arranged between the two plungers 34. The actual guides for the guide portions 36 of the blocking elements 35 can be arranged in the centre portions of the plunger housings 31, in the housing 12 below, or in both.

The plunger housings 31 can be regarded as part of the housing 12.

Compared with solutions known from the prior art, in which several separate piston rods are provided for guiding the yoke, the blocking elements 35 thus also assume the role of the guide elements of the yoke 30 in a dual function. Separate piston rods can therefore be dispensed with, which enables a particularly compact design. In addition, the arrangement of the blocking elements 35 according to the invention ensures that the yoke 30 in the exemplary embodiment shown here is guided by only two guide elements arranged in the centre plane 50, which reduces the likelihood of the yoke 30 jamming and increases its ease of movement.

The blocking, contact and guide portions 36, 37, 38 of the blocking elements 35 are preferably formed in one piece.

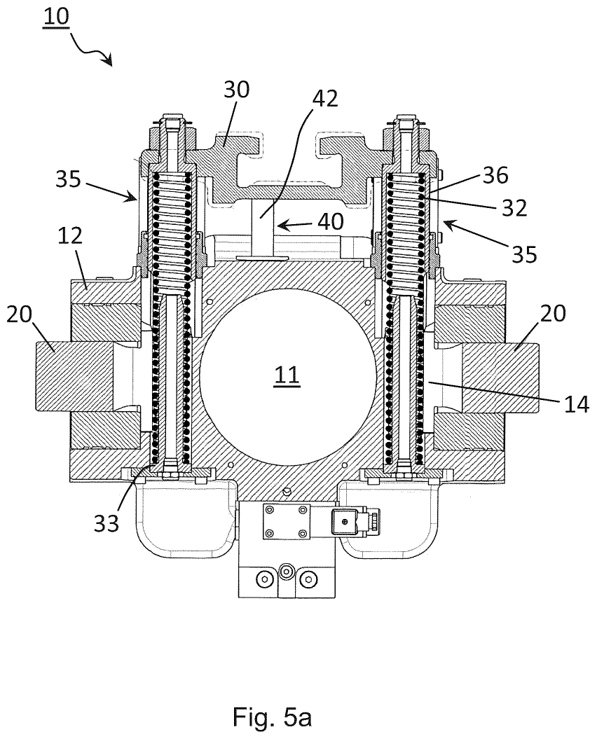

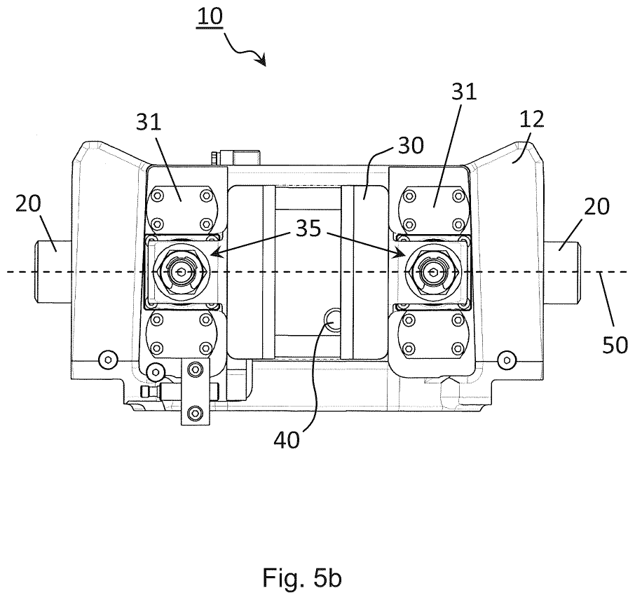

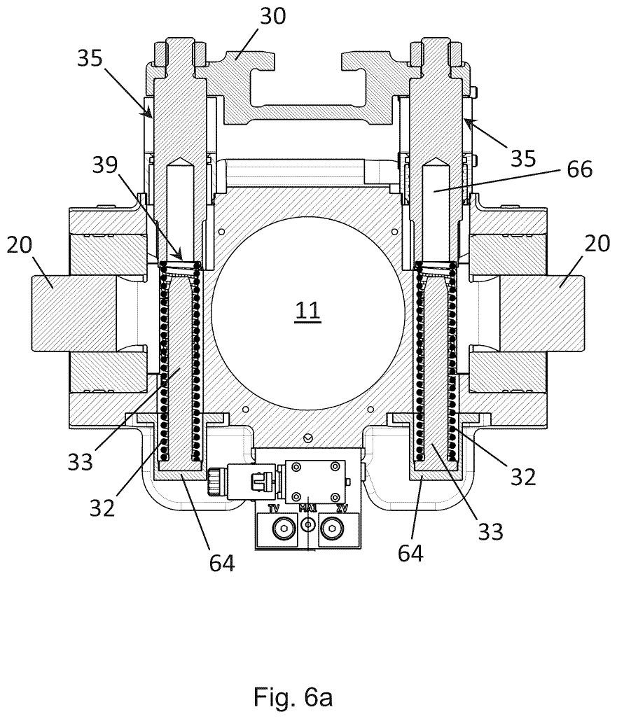

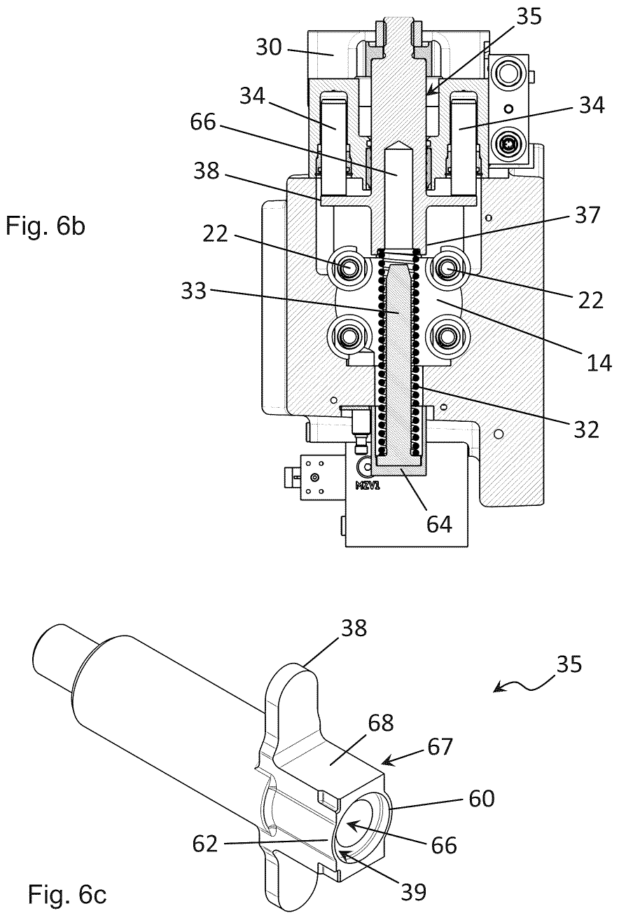

An alternative solution according to a second exemplary embodiment is shown in FIGS. 5a-b. Here, FIG. 5a shows a frontal sectional view of the locking device 10 through the two blocking elements 35 and FIG. 5b shows a plan view of the locking device 10. Here, reference signs already used for the first exemplary embodiment denote the same components.

The locking device 10 according to the second exemplary embodiment differs from the first exemplary embodiment in that, in addition to the two blocking elements 35, a third guide element 40 is provided, so that the yoke 30 is mounted and guided in the housing 12 via a total of three guide elements 35, 40, i.e. via a tripod. The further guide element 40 comprises a guide rod 42 connected to the underside of the clamp-shaped yoke 30, which is displaceably mounted and guided in a corresponding guide or bushing in the upper area of the housing 12. The guide or bushing is thus located below the yoke 30.

As can be seen in FIG. 5b, the further guide element 40 is arranged off-centre in relation to the yoke 30 in the exemplary embodiment shown here, i.e. it is located outside the central plane 50 spanned by the longitudinal axes of the bolts 20 and the blocking elements 35 and outside the plane running perpendicular to the central plane 50 through the centre of the yoke 30. The guide elements 35, 40 thus form the corner points of an irregular triangle. This results in the aforementioned tripod mounting of the yoke 30.

Alternatively, a tripod mounting could also be achieved by the further guide element 40 being arranged outside the centre plane 50 but inside the plane running perpendicular to the centre plane 50 through the centre of the yoke 30 and therefore forming an isosceles triangle. It is also conceivable to provide more than one further guide element 40.

FIGS. 6a-c show a third exemplary embodiment of the locking device 10 according to the invention. FIG. 6a shows the locking device 10 in a frontal sectional view through two blocking elements 35, FIG. 6b shows the locking device 10 in a lateral sectional view (rotated 90° to the view of FIG. 6a) through one of the blocking elements 35 and FIG. 6c shows a perspective view of one of the blocking elements 35 of this exemplary embodiment.

The locking device 10 according to the third exemplary embodiment differs from the first two exemplary embodiments in that the yoke return elements or compression springs 32 are mounted in a spring receptacle 39 with a shallow depth at the end portion of the respective blocking element 35 and not on the upper side of a bore extending through a substantial part of the blocking element 35.

As can be seen in FIG. 6c, the blocking element 35 of this exemplary embodiment has a circular opening 60 on the end face facing away from the yoke 30, which is surrounded by a wall 62. The recess formed by the wall 62 forms the spring receptacle 39 for the compression spring 32, which is supported on an annular projection that extends radially inwards from the wall 62. The projection merges into a cylindrical bore extending within the blocking element 35 in the direction of the yoke 30, which forms a mandrel receiving space 66. The mandrel receiving space 66 has a smaller diameter than the spring receptacle 39, so that the compression spring 32 does not enter the mandrel receiving space 66 in any position of the blocking element 35.

As can be seen in FIGS. 6a and 6b, in which the yoke 30 is in the locking position, the compression springs 32 therefore do not run (far) inside the blocking elements 35, but are mounted at their end portions in the spring receptacles 39. In the unlocking position of the yoke 30, in which the blocking portions 38 of the blocking elements 35 protrude into the travel paths of the bolts 20, the compression springs 32 are compressed and the spring mandrels 33 protrude through the openings 60 into the mandrel receptacles 66 (not shown).

In order to maintain a sufficient length of the compression springs 32 despite the support of the compression springs 32 now taking place further down in the area of the bolt return elements 22 on the blocking element 35, in this exemplary embodiment the bearing points of the spring mandrels 33 on the housing 12 of the locking cone 10 are offset downwards (i.e. away from the yoke 30). For this purpose, pot-shaped mandrel bearing portions 64 are provided on the housing 12, to the bases of which the spring mandrels 33 are attached.

As shown in FIG. 6c, the blocking elements 35 can have reinforcing portions 68 on the sides on which the wing-shaped projections of the contact portions 38 for the yoke actuators 34 are located, which run in the area of the blocking portions 37 and can be connected to the wall of the blocking element 35 or formed integrally therewith. As a result, the forces of the yoke actuators 34 can be better introduced into the blocking elements 35 and the latter can be reinforced in these areas.

The blocking elements 35 can also have a shape in the first two exemplary embodiments or in general which, apart from the front flat spring receptacle 39 and the narrower mandrel receiving space 66, corresponds to that of FIG. 6c. In particular, the blocking elements 35 in the first two exemplary embodiments also have circular openings 60 for the compression springs 32 on the end faces of the end portions or blocking portions 37, which project into the interior of the blocking elements 35 and are supported therein. Optionally, the reinforcement portions 68 shown can also be provided.

### LIST OF REFERNCE SIGNS

10 locking lock (locking head)
11 recess
12 housing
14 insertion space
16 screw
18 connection area
20 bolt
22 bolt return element (spring)
24 bolt actuator (plunger)
26 recess
28 contact portion
30 yoke
31 plunger housing
32 yoke return element (spring)
33 spring mandrel
34 yoke actuator (plunger)
35 blocking element

36 guide portion
37 blocking portion
38 contact portion
39 spring receptacle
40 further guide element
42 guide rod
50 centre plane
60 opening
62 wall
64 mandrel bearing portion
66 mandrel receiving space
68 reinforcing portion

1. A locking device for the telescopic cylinder of a telescopic boom comprising a plurality of telescopic stages, comprising:
a housing,
at least one bolt displaceably mounted in the housing for locking the telescopic cylinder with a telescopic stage, wherein the bolt is preloaded into a locking position via at least one bolt return element and can be displaced into an unlocking position via at least one bolt actuator,
a yoke displaceably mounted in the housing, which can be moved into an unlocking position to release a locking bolt of the telescopic boom,
at least one blocking element which blocks a movement of the bolt into its unlocking position when the yoke is in the unlocking position, wherein the blocking element and the bolt are at least partially displaceable into a common insertion space of the housing,
wherein
the bolt is preloaded into the locking position via at least two bolt return elements, wherein the blocking element is arranged between the bolt return elements as seen in the direction of displacement of the yoke.

2. The locking device according to claim 1, wherein the at least one blocking element is simultaneously designed as a guide element, via which the yoke is guided in the housing.

3. The locking device according to claim 1, wherein the bolt return elements run perpendicular to the longitudinal axis of the blocking element and/or at least partially within the insertion space.

4. The locking device according to claim 1, wherein the bolt is preloaded into the locking position via at least two bolt return elements, and/or wherein the bolt return elements are arranged symmetrically to the longitudinal axis of the blocking element as seen in the direction of displacement of the bolt.

5. The locking device according to claim 1, wherein the yoke is preloaded into a locking position via at least one yoke return element.

6. The locking device according to claim 5, wherein the blocking element has a blocking portion which, in the unlocking position of the yoke, projects into a travel path of the bolt within the insertion space;

7. The locking device according to claim 5, wherein two yoke actuators are provided, which are arranged symmetrically to the blocking element as seen in the direction of displacement of the bolt.

8. The locking device according to claim 5, wherein the yoke return element is a compression spring which is arranged coaxially to the blocking element.

9. The locking device according to claim 5, wherein the yoke return element is arranged at least partially in the insertion space, wherein the bolt has a recess.

10. The locking device according to claim 5, wherein the yoke actuator and/or the bolt actuator comprises or represents a hydraulic cylinder.

11. The locking device according to claim 1, wherein two bolts are provided for locking the telescopic cylinder with a telescopic stage, wherein at least one blocking element is associated with each bolt, which blocking element is arranged between the bolt return elements of the respective bolt as seen in the direction of displacement of the latter.

12. The locking device according to claim 2, wherein exactly two blocking elements are provided, which function as guide elements, wherein a further guide element is provided, so that the yoke is guided in the housing via a total of three guide elements.

13. The locking device according to claim 12, wherein the blocking elements are arranged centrally on opposite sides of the yoke.

14. The locking device according to claim 5, wherein exactly four yoke return elements are provided, which are arranged axially symmetrically to a centre plane spanned by the longitudinal axes of a plurality of blocking elements.

15. The locking device according to claim 1, wherein an end portion of the blocking element projecting into a travel path of the bolt within the insertion space has at its end face an opening completely enclosed by a wall.

16. The locking device according to claim 15, wherein a mandrel receiving space formed inside the blocking element adjoins the spring receptacle, which is designed in such a way that a spring mandrell running in the insertion space and on which the yoke return element is mounted projects into the mandrel receiving space in an unlocking position of the yoke, but the yoke return element is always located outside the mandrel receiving space.

17. An implement, having a telescopic boom comprising a plurality of telescopic stages displaceably mounted inside one another, a hydraulic telescopic cylinder for extending and retracting at least one inner telescopic stage and a locking device connected to the telescopic cylinder according to claim 1.

18. The locking device of claim 2, wherein the blocking element has a guide portion which is displaceably mounted and guided in a guide of the housing.

19. The locking device of claim 6, wherein the yoke is displaceable into the unlocking position via at least one yoke actuator wherein the blocking element further has a contact portion which is connected to the at least one yoke actuator or is contacted by the latter.
